(19) United States
(12) Patent Application Publication
(10) Pub. No.: US 2014/0013571 A1
(43) Pub. Date: Jan. 16, 2014

(54) WEB RESTRAINT SYSTEM

(71) Applicant: GULFSTREAM SERVICES, INC., Houma, LA (US)

(72) Inventors: Robert BOND, III, Houma, LA (US); Michael MIRE, Kenner, LA (US)

(73) Assignee: GULFSTREAM SERVICES, INC., Houma, LA (US)

(21) Appl. No.: 13/907,586

(22) Filed: May 31, 2013

Related U.S. Application Data
(60) Provisional application No. 61/656,276, filed on Jun. 6, 2012.
(60) Provisional application No. 61/727,521, filed on Nov. 16, 2012.

(51) Int. Cl. F16L 3/26

(52) U.S. Cl. CPC F16L 3/26
USPC 29/428; 248/49

(57) ABSTRACT

A web restraint system for use in securing temporary flow lines that include multiple pipe sections, each pair of pipe sections connected together with a coupling such as a hammer joint coupling. The system includes one or more elongated spines, each spine having end portions that are secured to provided anchors. A webbing is sized and shaped to envelope a coupling or hammer joint connection (and preferably each). The webbing or netting has peripheral loops which enable a technician to secure the spine to the webbing loops. A second plurality of loops can be used to secure the webbing to the ends of the pipe sections that are connected together with a said coupling or hammer joint connection.

### CROSS-REFERENCE TO RELATED APPLICATIONS

This is a non provisional patent application of U.S. Provisional Patent Application Ser. No. 61/656,276, filed 6 Jun. 2012; and U.S. Provisional Patent Application Ser. No. 61/727,521, filed 16 Nov. 2012.

Priority of U.S. Provisional Patent Application Ser. No. 61/656,276, filed 6 Jun. 2012; and U.S. Provisional Patent Application Ser. No. 61/727,521, filed 16 Nov. 2012, each of which is hereby incorporated herein by reference, is hereby claimed.

### STATEMENT REGARDING FEDERALLY SPONSORED RESEARCH OR DEVELOPMENT

Not applicable

### REFERENCE TO A “MICROFICHE APPENDIX”

Not applicable

### BACKGROUND OF THE INVENTION

1. Field of the Invention

The present invention relates to devices for restraining high pressure flow lines. More particularly the present invention relates to a net or matrix of straps or ropes that form a shaped expansive wrap (e.g., square, rectangular, triangular, etc.) that can envelope a fitting, coupling or joint between two sections of high pressure pipe. In one embodiment the joint may have radially projecting portions that engage portions of the net or wrap and wherein loops at the periphery of the net or wrap enable connection to an elongated spine or to a plurality of loops that wraps about the pipe next to the coupling or joint.

2. General Background of the Invention

In the offshore oil and gas industry, temporary high pressure pipelines are often employed at or near a drilling platform or drilling rig or upon a deck of a drilling platform or drilling rig. These high pressure pipelines are assembled using couplings which are also high pressure rated. If one of these sections of pipe or coupling that make up the high pressure flow line fail or leak, there can be injury or death to personnel and/or damage to equipment.

Patents have issued for restraint systems designed to restrain a flow line or parts thereof. The following are examples of such patents:

U.S. Pat. Nos. 2,746,773; 5,689,862; 6,481,457 (each patent hereby incorporated herein by reference).

The '457 Patent is directed to a “Safety Restraint Assembly for High Pressure Flow Line”. The patent is owned by S.P.M. Flow Controls, Inc. of Fort Worth, Texas (hereinafter “S.P.M.”).

A Society of Petroleum Engineers publication which is identified by the numeral SPE 24619 and entitled “Restraining System to Help Contain Well Flow Lines and Equipment During Rupture for Increased Safety” was said to have been prepared for presentation at the 87th Annual Technical Conferences and Exhibition of the Society of Petroleum Engineers held in Washington, D.C., Oct. 4-7, 1992.

### BRIEF SUMMARY OF THE INVENTION

The present invention provides a web restraint system for use in securing temporary flow lines that include multiple pipe sections, each pair of sections connected together with a pressure holding coupling such as a hammer coupling.

The system includes one or more elongated spines, each spine having end portions that are secured to provided anchors.

A specially configured webbing or net is sized and shaped to envelope the coupling or a fitting for a flow line and at least part of the ends of one or two connected flow line sections.

The webbing or net has a periphery with a first plurality of peripheral loops that enable the net to be secured to the spine with a connection wherein the spine passes through one or more of the loops. The spine can pass through loop openings of the loops.

The webbing or net has a second plurality of loops that enable connection to the ends of the pipe sections.

The loops of the first and second pluralities can be arranged in alternating positions.

In one embodiment, the webbing or net is a rectangular shape.

In one embodiment, the webbing or net is a square shape.

In one embodiment, the webbing or net is a triangular shape.

In one embodiment, the webbing or net is comprised of a matrix of straps that include a first plurality of parallel straps and a second plurality of parallel straps that are not parallel to the first plurality of parallel straps.

In one embodiment, one or more straps of the first plurality of parallel straps has one or more of said first plurality of loops.

In one embodiment, the one or more straps of the second plurality of parallel straps has one or more of said second plurality of loops.

In one embodiment, the webbing or net is comprised of a plurality of apart straps with spaces between the straps, said straps including a first plurality of straps and a second plurality of straps, wherein each strap of the first plurality of straps is stitched to at least two of the straps of the second plurality of straps.

In one embodiment, the webbing or net is comprised of a plurality of apart straps with spaces between the straps, said straps including a first plurality of straps and a second plurality of straps, wherein each strap of the first plurality of straps is stitched to at least two of the straps to the second plurality of straps and wherein each strap has a strap end portion connected to a said peripheral loop.

In one embodiment, each strap has an end portion that is folded and stitched to form one of said peripheral loops.

In one embodiment the system includes multiple anchors.

The present invention provides a method for restraining a temporary flow line that includes multiple pipe sections, each pair of sections connected together with a disconnectable coupling.

As part of the method, there is provided one or more elongated spines, each spine having end portions that are secured to provided anchors.

A webbing or net or woven structure is provided that is sized and shaped to envelope a coupling for a flow line and at least part of the ends of the flow line sections, and for enveloping the net around the temporary flow line at the coupling.

The webbing or net or woven structure has a periphery with a first plurality of peripheral loops, and the method further contemplates connecting the net to the spine with a connection wherein the spine passes through one or more of the loops.

The ends of the pipe sections are connected to the net through multiple of said peripheral loops.

In one embodiment, the spine is connected to loops on opposing sides of the net or woven structure.

In one embodiment, the webbing or net or woven structure is generally rectangular, and the spine is connected to loops on opposing sides of the net that overlap when the net is enveloped around a pipe section or coupling.

In one embodiment, the spine is connected to loops on opposing sides of the net that overlap when the net is enveloped around a pipe section or coupling, wherein the spine passes through a loop from one side of the net and then through a loop on the other side of the net.

In one embodiment, the webbing or net is rectangular, having four sides, each side having multiple of said peripheral loops, the method further including connecting the spine to the loops of a first and a third side and connecting pipe sections to the loops of a second and fourth side.

The present invention includes a web restraint system for use in securing high pressure flowlines that include multiple pipe sections, wherein each pair of flowline sections is connected together with a hammer coupling. The system includes multiple anchors and one or more elongated spines, each spine having end portions that are secured or connectable to an anchor. An array of straps can be sized and shaped to envelope a coupling and at least part of the ends of a pair of flowline sections. The array can have a periphery with first and second pluralities of peripheral loops that enable the net to be secured to the spine with a connection that is perfected when the spine passes through one or more of the loops. The loops of the first and second pluralities arranged in alternating positions.

In one embodiment, the array can be a rectangular shape.

In one embodiment, the array can be a square shape.

In one embodiment, the array can be a triangular shape.

In one embodiment, the array can be comprised of a plurality of straps that include a first plurality of parallel straps and a second plurality of parallel straps that are not parallel to the first plurality of parallel straps.

In one embodiment, one or more straps of the first plurality of parallel straps has one or more of said first plurality of loops.

In one embodiment, the one or more straps of the second plurality of parallel straps has one or more of said second plurality of loops.

In one embodiment, the array is comprised of a plurality of apart straps with spaces between the straps, said straps including a first plurality of straps and a second plurality of straps, wherein each strap of the first plurality of straps is fastened to at least two of the straps of the second plurality of straps.

In one embodiment, the array is comprised of a plurality of apart straps with spaces between the straps, said straps including a first plurality of straps and a second plurality of straps, wherein each strap of the first plurality of straps is stitched to at least two of the straps of the second plurality of straps.

In one embodiment, the array is comprised of a plurality of apart straps with spaces between the straps, said straps including a first plurality of straps and a second plurality of straps, wherein each strap of the first plurality of straps is stitched to at least two of the straps to the second plurality of straps and wherein each strap has a strap end portion connected to a said peripheral loop.

In one embodiment, each strap has an end portion that is folded and stitched to form one of said peripheral loops.

The present invention includes a method for restraining a high pressure flow line that includes multiple pipe sections, each pair of pipe sections connected together with a disconnectable coupling. As part of the method, there is provided one or more anchors and one or more elongated spines, each spine having end portions. The method further includes securing the end portions of the spines to said one or more anchors. A woven structure can be sized and shaped to envelope a coupling for a flow line and at least part of the ends of the flow line sections, and enveloping the woven structure around the high pressure flow line at the coupling. The woven structure can have a periphery with a first plurality of peripheral loops and a second plurality of peripheral loops. The method further includes connecting the woven structure to the spine with a connection wherein the spine passes through multiple of the first plurality of loops and multiple of the second plurality of loops by alternating wherein the spine passes through one loop of the first plurality, one loop of the second plurality, another loop of the first plurality, another loop of the second plurality and then alternating between one loop of the first plurality and one loop of the second plurality until the spine passes through all of the said loops. The method further includes connecting the ends of the pipe sections to the woven structure, wherein the loops of the first and second pluralities are arranged in alternating positions.

In one embodiment, the spine is connected to loops on opposing sides of the woven structure.

In one embodiment, the woven structure is generally rectangular, and the spine is connected to loops on opposing sides of the woven structure that overlap when the woven structure is enveloped around a pipe section or coupling.

In one embodiment, the spine is connected to loops on opposing sides of the woven structure that overlap when the woven structure is enveloped around a pipe section or coupling, wherein the spine passes through a loop from one side of the woven structure and then through a loop on the other side of the woven structure.

In one embodiment, the woven structure is rectangular, having four sides, each side having multiple of said peripheral loops, the method further including connecting the spine to the loops of a first and a third side and connecting pipe sections to the loops of a second and fourth side.

The present invention includes a web restraint system for use in securing temporary flowlines that include multiple pipe sections, each pair of sections connected together with one or more fittings. The system includes a plurality of anchors and one or more elongated spines, each spine having end portions that are secured to said anchors. A net is sized and shaped to envelope a fitting for a temporary flowline and at least part of the ends of the flowline sections next to said fittings. The net has a periphery with first and second pluralities of peripheral loops that enable the net to be secured to the spine with a connection wherein the spine passes through multiple loop openings of the loops.

The present invention includes a method for restraining a temporary flow line that includes multiple pipe sections, each pair of sections connected together with a disconnectable coupling. The method includes providing first and second anchors and one or more elongated spines, each spine having first and second spine end portions, each end portion secured to a provided anchor. A net is provided that is sized and shaped to envelope a said coupling. The net has a periphery with first and second pluralities of peripheral loops. The net is connected to the spine with a connection wherein the spine passes through multiple loops of the first and of the second plurality of loops.

The present invention includes a web restraint system for use in securing high pressure flowlines that include multiple pipe sections, wherein each pair of flowline sections is connected together with a hammer coupling. The invention includes first and second anchors and one or more elongated spines, each spine having end portions that are secured to an anchor, wherein one spine end portion is connected to the first anchor and the other spine end portion is connected to the second anchor. An array of straps that is sized and shaped to envelope a coupling and at least part of the ends of a pair of flowline sections. The array has a periphery with first and second pluralities of peripheral loops that enable the net to be secured to the spine with a connection that is perfected when the spine passes through multiple of the loops of the first plurality and multiple of the loops of the second plurality.

The present invention includes a method for restraining a high pressure flow line that includes multiple pipe sections, each pair of pipe sections connected together with a disconnectable coupling. The method provides one or more anchor and one or more elongated spines, each spine having end portions. The end portions of the spines can be secured to said one or more anchors. A woven structure is provided that is sized and shaped to envelope a said coupling. The woven structure is enveloped around the high pressure flow line at the coupling. The woven structure has a periphery with a first plurality of peripheral loops and a second plurality of peripheral loops. The woven structure is connected to the spine with a connection wherein the spine passes through multiple of the first plurality of loops and multiple of the second plurality of loops by alternating wherein the spine passes through one loop of the first plurality, one loop of the second plurality, another loop of the first plurality, another loop of the second plurality and then alternating between one loop of the first plurality and one loop of the second plurality until the spine passes through all of the said loops.

### BRIEF DESCRIPTION OF THE SEVERAL VIEWS OF THE DRAWINGS

For a further understanding of the nature, objects, and advantages of the present invention, reference should be had to the following detailed description, read in conjunction with the following drawings, wherein like reference numerals denote like elements and wherein:

FIG. 1 is a partial top perspective view of a preferred embodiment of the apparatus of the present invention;

FIG. 2 is a sectional view taken along lines 2-2 of FIG. 1;

FIG. 3 is a partial perspective view of a preferred embodiment of the apparatus of the present invention;

FIG. 4 is a partial perspective view of a preferred embodiment of the apparatus of the present invention; and

FIG. 5 is a perspective view of a preferred embodiment of the apparatus of the present invention.

### DETAILED DESCRIPTION OF THE INVENTION

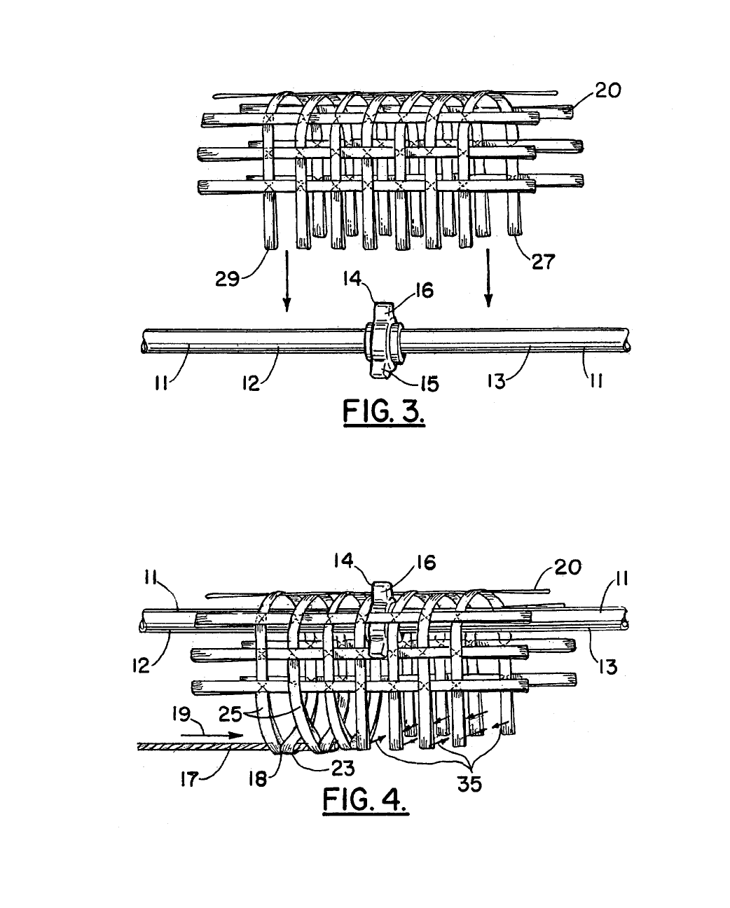

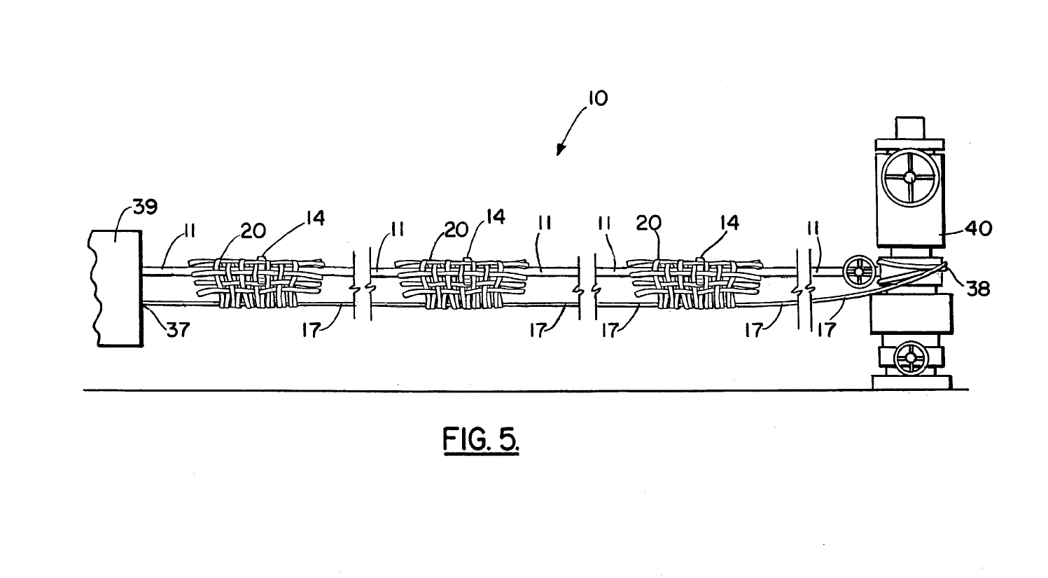

FIGS. 1-5 show a preferred embodiment of the apparatus of the present invention designated generally by the numeral 10 in FIG. 5. Restraint system 10 is used to secure a high pressure flow line 11 that can be comprised of a plurality of pipe sections 12, 13 and fittings 14 (e.g., couplings, valves, elbows, tees or other fittings) (see FIGS. 3).

In FIG. 3, two pipe sections 12, 13 are shown connected at fitting 14. However, the term “fitting” as used herein should be construed broadly to include anything that can be part of a flowline. Fitting includes but is not limited to elbows, tees, reducers, valves, couplings, unions, for example. In such a high pressure flow line 11, multiple pipe sections are typically connected end to end.

A fitting 14 (e.g., a coupling such as a hammer union 14, which is commercially available) is used to join a pair of pipe sections 12, 13 together. Such hammer unions, couplings or like fittings 14 are known in the art. Coupling 14 can provide a hammer nut 15 which can be pounded with a hammer to ensure a tight seal for the connection of coupling or fitting 14 when it is used to join two pipe sections 12, 13 together. An example of a hammer union and seal arrangement can be seen in U.S. Pat. No. 6,764,109 entitled “Hammer Union and Seal Therefor”. U.S. Pat. No. 6,764,109 is hereby incorporated herein by reference.

In FIGS. 3 and 4, a projection 16 of hammer nut 15 of hammer union or coupling 14 is shown extending through a provided array of straps or net or webbing 20 (see FIGS. 1, 3, 4). The array 20 is preferably an array of straps that are connected together, spaces 31 being provided in between each pair of straps. In FIG. 1, there is provided a first plurality of straps 21 and a second plurality of straps 22. The first plurality of straps 21 are parallel to one another. The second plurality of straps 22 are parallel to each other. The second plurality of straps 22 are not parallel to the first plurality of straps 21. Each strap 21 of the first plurality of straps can be generally perpendicular to each strap 22 of the second plurality of straps (see FIG. 1).

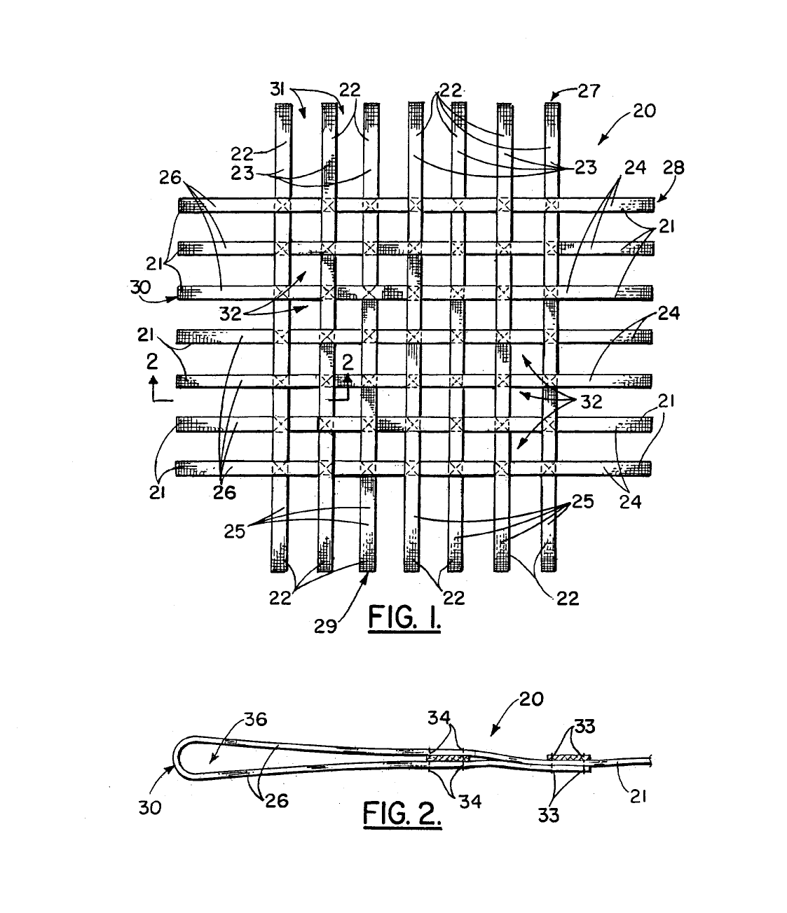

The array of straps 20 has a periphery as defined by the sides of the net or webbing or array 20. These sides include side 27, side 28, side 29, and side 30 (see FIG. 1). At each of the sides 27-30, there are provided a plurality of loops. The loops can be end portions of the straps 21, 22 that are folded and stitched or fastened as shown at stitching 34 in FIG. 2.

A first plurality of loops 23 is provided at the first side 27 of net or webbing or array 20. A second plurality of loops 24 is provided at the second side 28 of net or webbing or array 20. A third side 29 of net or webbing or array 20 has a third plurality of loops 25. A fourth side 30 of net or webbing or array 20 provides a fourth plurality of loops 26. As can be seen in the drawings, there is space 31 between each pair of straps (see FIG. 1). Each loop in the plurality of loops 23, 24, 25, 26 has a loop opening 36 that can receive spine 17 (see FIGS. 2, 5). Four straps surround an opening 32 (see FIG. 1). In the drawings, stitching is provided at 33, 34 (see FIG. 2). The stitching 33 joins each strap 21 to another strap 22. The stitching 34 forms a loop with an end portion of a strap 21 or 22 (see FIG. 2).

FIGS. 3 and 4 depict the net or webbing 20 in relation to the fitting or coupling 14 and high pressure flow line 11. In FIG. 4, net or webbing 20 has been wrapped around a fitting (e.g., coupling) 14. Spine 17 would then be threaded through the opening 36 of loops 23, 25 (see arrow 19, FIG. 4) at respective sides 27, 29 of webbing or net 20 (see FIGS. 3-4). Spine 17 can be comprised of one cable or multiple aligned cables or multiple cables connected together end to end. In FIG. 4, the numeral 18 designates a connection of spine 17 to loops 23, 25. Arrows 35 illustrate an alternating alignment of loops 23 with loops 25. In FIG. 4, spine 17 passes first through a loop 25 of side 29, then through a loop 23 of side 27 and then through the next loop 25 of side 29. The spine 17 thus passes through each opening 36 of each loop 23 of side 27 and each loop 25 of side 29.

Spine 17 can be in the form of a loop or circle (or have loop ends) so that one spine 17 can be easily joined to another spine 17. FIG. 5 shows multiple spines 17 joined together. Spine 17 is anchored to an immovable object or anchor 39, 40. Spine 17 has first end 37 attached to first anchor 39. Spine 17 has second spine end 38 attached to second anchor 40.

The following is a list of parts and materials suitable for use in the present invention:

PARTS LIST:

| PART NUMBER | DESCRIPTION |
|---|---|
| 10 | restraint system |
| 11 | high pressure flow line |
| 12 | pipe section |
| 13 | pipe section |
| 14 | coupling/hammer union/fitting |
| 15 | hammer nut |
| 16 | projection |
| 17 | spine |
| 18 | connection |
| 19 | loop arrow |
| 20 | array of straps/net/webbing |
| 21 | first plurality of straps |
| 22 | second plurality of straps |
| 23 | first plurality of loops |
| 24 | second plurality of loops |
| 25 | third plurality of loops |
| 26 | fourth plurality of loops |
| 27 | side of net/webbing |
| 28 | side of net/webbing |
| 29 | side of net/webbing |
| 30 | side of net/webbing |
| 31 | space |
| 32 | opening |
| 33 | stitching |
| 34 | stitching |
| 35 | arrows |
| 36 | loop opening |
| 37 | first spine end |
| 38 | second spine end |
| 39 | first anchor |
| 40 | second anchor |

All measurements disclosed herein are at standard temperature and pressure, at sea level on Earth, unless indicated otherwise. All materials used or intended to be used in a human being are biocompatible, unless indicated otherwise.

The foregoing embodiments are presented by way of example only; the scope of the present invention is to be limited only by the following claims.

1-10. (canceled)

11. A method for restraining a temporary flow line that includes multiple pipe sections, each pair of sections connected together with a disconnectable coupling, comprising the steps of:
a) providing first and second anchors;
b) providing one or more elongated spines, each spine having first and second spine end portions, each said end portion secured to a said provided anchor of step “a”;
c) providing a net that is sized and shaped to envelope a said coupling;
d) the net having a periphery with first and second pluralities of peripheral loops; and
e) connecting the net to the spine with a connection wherein the spine passes through multiple loops of the first and of the second plurality of loops.

12. The method of claim 11 wherein the spine is connected to loops on opposing sides of the net.

13. The method of claim 11 wherein the net is generally rectangular, and the spine is connected to loops on opposing sides of the net that overlap when the net is enveloped around a pipe section or coupling.

14. The method of claim 11 wherein the spine is connected to loops on opposing sides of the net that overlap when the net is enveloped around a pipe section or coupling, wherein the spine passes through a loop from one side of the net and then through a loop on the other side of the net.

15. The method of claim 11 wherein the net is rectangular, having four sides, each side having multiple of said peripheral loops, the method further including connecting the spine to the loops of a first and a third side and connecting the pipe sections to the loops of a second and fourth side.

16. A web restraint system for use in securing high pressure flowlines that include multiple pipe sections, wherein each pair of flowline sections is connected together with a hammer coupling, the system comprising:
a) first and second anchors;
b) one or more elongated spines, each spine having end portions that are secured to a said anchor, wherein one spine end portion is connected to the first anchor and the other spine end portion is connected to the second anchor;
c) an array of straps that is sized and shaped to envelope a coupling and at least part of the ends of a pair of flowline sections; and
d) the array having a periphery with first and second pluralities of peripheral loops that enable the net to be secured to the spine with a connection that is perfected when the spine passes through multiple of the loops of the first plurality and multiple of the loops of the second plurality.

17. The restraint system of claim 16 wherein the array is a rectangular shape.

18. The restraint system of claim 16 wherein the array is a square shape.

19. The restraint system of claim 16 wherein the array is a triangular shape.

20. The restraint system of claim 16 wherein the array is comprised of a plurality of straps that include a first plurality of parallel straps and a second plurality of parallel straps that are not parallel to the first plurality of parallel straps.

21. The restraint system of claim 20 wherein one or more straps of the first plurality of parallel straps has one or more of said first plurality of loops.

22. The restraint system of claim 20 wherein the one or more straps of the second plurality of parallel straps has one or more of said second plurality of loops.

23. The restraint system of claim 16 wherein the array is comprised of a plurality of apart straps with spaces between the straps, said straps including a first plurality of straps and a second plurality of straps, wherein each strap of the first plurality of straps is fastened to at least two of the straps of the second plurality of straps.

24. The restraint system of claim 16 wherein the array is comprised of a plurality of apart straps with spaces between the straps, said straps including a first plurality of straps and a second plurality of straps, wherein each strap of the first plurality of straps is stitched to at least two of the straps of the second plurality of straps.

25. The restraint system of claim 16 wherein the array is comprised of a plurality of apart straps with spaces between the straps, said straps including a first plurality of straps and a second plurality of straps, wherein each strap of the first plurality of straps is stitched to at least two of the straps to the second plurality of straps and wherein each strap has a strap end portion connected to a said peripheral loop.

26. The restraint system of claim 23 wherein each strap has an end portion that is folded and stitched to form one of said peripheral loops.

27. A method for restraining a high pressure flow line that includes multiple pipe sections, each pair of pipe sections connected together with a disconnectable coupling, comprising the steps of:
a) providing one or more anchors;
b) providing one or more elongated spines, each spine having end portions;
c) securing the end portions of the spines to said one or more anchors;
d) providing a woven structure that is sized and shaped to envelope a said coupling;
e) enveloping the woven structure around the high pressure flow line at the coupling;
f) the woven structure having a periphery with a first plurality of peripheral loops and a second plurality of peripheral loops;
g) connecting woven structure to the spine with a connection wherein the spine passes through multiple of the first plurality of loops and multiple of the second plurality of loops by alternating wherein the spine passes through one loop of the first plurality, one loop of the second plurality, another loop of the first plurality, another loop of the second plurality and then alternating between one loop of the first plurality and one loop of the second plurality until the spine passes through all of the said loops.

28. The method of claim 27 wherein the spine is connected to loops on opposing sides of the woven structure.

29. The method of claim 27 wherein the woven structure is generally rectangular, and the spine is connected to loops on opposing sides of the woven structure that overlap when the woven structure is enveloped around a pipe section or coupling.

30. The method of claim 27 wherein the spine is connected to loops on opposing sides of the woven structure that overlap when the woven structure is enveloped around a pipe section or coupling, wherein the spine passes through a loop from one side of the woven structure and then through a loop on the other side of the woven structure.

31. The method of claim 27 wherein the woven structure is rectangular, having four sides, each side having multiple of said peripheral loops, the method further including connecting the spine to the loops of a first and a third side and connecting pipe sections to the loops of a second and fourth side.
